(19) United States
(12) Patent Application Publication
(10) Pub. No.: US 2002/0047752 A1
(43) Pub. Date: Apr. 25, 2002

(54) Nonreciprocal circuit device and communication device

(75) Inventors: Hiroki Dejima, Kanazawa-shi (JP); Akihito Masuda, Kanazawa-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/882,993

(22) Filed: Jun. 14, 2001

(30) Foreign Application Priority Data
Jun. 14, 2000 (JP) 2000-179060

(51) Int. Cl. H01P 1/36

(52) U.S. Cl. 333/24.2; 333/1.1

(57) ABSTRACT

On a ferrite, central conductors are disposed so as to intersect each other, whereby a magnetic assembly is formed. A permanent magnet for applying a direct-current magnetic field to the ferrite 54 is provided. The residual flux density of the permanent magnet is at least 0.420 [T], the coercive force iHc is at least 344 [kA/m], and the coercive force bHc is at least 320 [kA/m].

### BACKGROUND OF THE INVENTION

1. Field of the Invention

The present invention relates to a nonreciprocal circuit device such as an isolator, a circulator, or the like for use in a high frequency band such as a microwave band and so forth, and a communication device having the same.

2. Description of the Related Art

Conventionally, lumped-constant type circulators each comprise a plurality of central conductors arranged adjacently to a ferrite sheet and intersecting each other, and a magnet for applying a direct-current magnetic field to the ferrite sheet which are housed in a case. Furthermore, isolators each comprise a predetermined port of the three ports of the circulator which is resistance-terminated.

More concretely, the above-mentioned central conductors are connected to each other in a connection portion having the same shape and size as the bottom of the ferrite. The ferrite is placed in the connection portion. The three central conductors protruding from the connection portion are disposed at an angle of substantially 120° to each other and are bent so as to wrap the ferrite, whereby a magnetic assembly is formed. The magnetic assembly, with a matching capacitor and the terminating resistor, are housed in a resin case. The resin case and the permanent magnet are enclosed by upper and lower yokes having a case shape and made of magnetic metal, whereby an isolator is formed.

In the above-described conventional isolator, a permanent magnet having as characteristics a residual flux density of about 0.38 [T], a coercive force (iHc) of about 290 [kA/m], and a coercive force (bHc) of about 270 [kA/m] is used. Here, the symbol iHc represents the magnetic field strength at an intensity 4 πI of magnetization of zero, and the symbol bHc represents the strength of a magnetic field at a magnetic flux density B of zero.

In recent years, with reduction in size and weight of mobile communication devices, it has been more demanded to reduce the size, height, and weight of nonreciprocal circuit devices.

Conventionally, in mobile communication devices, isolators having an outside size of about 7 mm×7 mm×2.5 mm and a weight of about 0.4 kg have been mainly used. However, isolators having an outside size of about 5 mm×5 mm×2 mm, and a weight of about 0.2 g has begun to be mainly employed. It is estimated that such requirements for reduction in size and weight will be also made in future.

In this background, to realize further reduction in height and weight, it is indispensable to decrease the thickness and the weight of the permanent magnet.

However, the reduction in thickness of the permanent magnet exerts a direct influence over the magnetic force applied to the above-described magnetic assembly in such a manner that the magnetic force is reduced. This causes a severe problem, that is, deterioration of the nonreciprocal characteristic.

### SUMMARY OF THE INVENTION

Accordingly, it is an object of the present invention to provide a nonreciprocal circuit device of which the size and the weight can be reduced, in which deterioration of the characteristic is suppressed, and a communication device having the same.

To achieve the above object, according to the present invention, there is provided a nonreciprocal circuit device which comprises a plurality of central conductors arranged so as to intersect each other in the electrical insulation state, a ferrite disposed in contact with the intersection portions of the plurality of central conductors, and a permanent magnet for applying a direct-current magnetic field to the ferrite, the permanent magnet having a residual flux density of at least 0.420 [T], a coercive force iHc of at least 344 [kA/m], and a coercive force bHc of at least 320 [kA/m].

Preferably, the permanent magnet is a ferrite magnet having lanthanum and cobalt added thereto.

More preferably, the addition amount of lanthanum contained in the ferrite magnet is in the range of from 0.5 mol % to 5 mol %, and the addition amount of cobalt is in the range of from 0.5 mol % to 5 mol %.

The permanent magnet may have a thickness of 1 mm or less.

Preferably, the temperature coefficient of the residual flux density of the permanent magnet is substantially equal to the temperature coefficient of the saturation magnetization of the ferrite.

Moreover, the temperature coefficient of the residual flux density of the permanent magnet and the temperature coefficient of the saturation magnetization of the ferrite may be in the range of from −0.12%/°C. to −0.35%/°C.

Moreover, according to the present invention, there is provided a communication device which includes the nonreciprocal circuit device having the above described configurations.

### BRIEF DESCRIPTION OF THE DRAWINGS

FIG. 1 is an exploded perspective view of an isolator according to an embodiment of the present invention;

FIG. 2 is an equivalent circuit diagram of the isolator;

FIG. 3A is a graph showing changes in residual flux density, based on different addition amounts of lanthanum in a permanent magnet for use in the isolator;

FIG. 3B is a graph showing changes in residual flux density, based on different addition amounts of cobalt in a permanent magnet for use in the isolator;

FIG. 4A is a graph showing changes in coercive force, based on different addition amounts of lanthanum in a permanent magnet for use in the isolator;

FIG. 4B is a graph showing changes in coercive force, based on different addition amounts of cobalt in a permanent magnet for use in the isolator; and

FIG. 5 is a block diagram showing the configuration of a communication device according to a second embodiment of the present invention.

### DESCRIPTION OF THE PREFERRED EMBODIMENTS

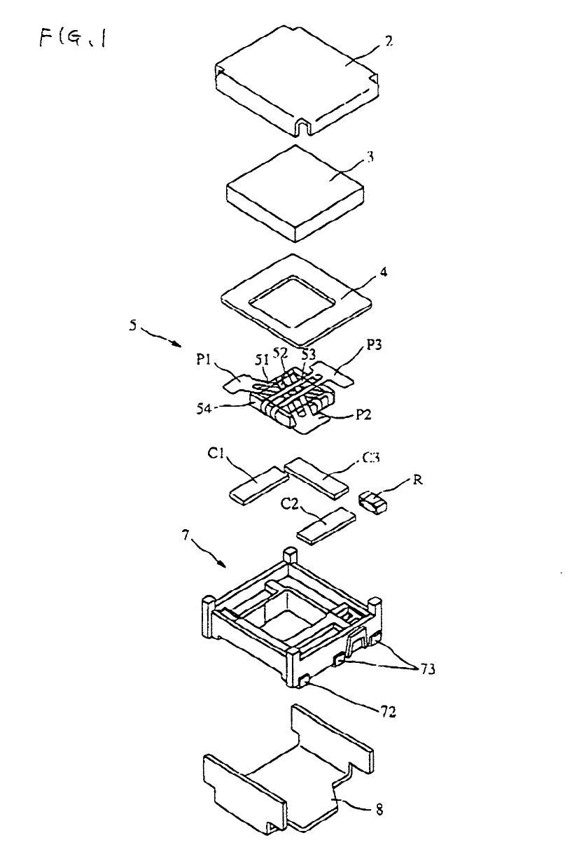

The configuration of an isolator according to an embodiment of the present invention will be described with reference to FIGS. 1 to 4.

FIG. 1 is an exploded perspective view of the isolator. In FIG. 1, an upper yoke 2 made of magnetic metal and having a case shape, and a permanent magnet 3 having a rectangular plate shape and disposed inside of the upper yoke 2 are shown. In a magnetic assembly 5, a ferrite 54 is placed in the connection portion of central conductors. The connection portion has substantially the same shape and size as the bottom of the ferrite 54. The three central conductors 51, 52, and 53 extending from the connection portion are bent at an angle of about 120° to each other with insulation sheets (not shown) being interposed between the central conductors, and are arranged so as to wrap around the ferrite 54, so that the ports on the tip portion thereof are outwardly protruded. A spacer 4 for maintaining the magnetic assembly 5 and the permanent magnet 3 at a predetermined distance is provided. In a resin case 7, a ground electrode a part of which is exposed to the upper face of the case on the inside thereof, an input-output terminal 72, a ground terminal 73, and so forth, which are exposed to the bottom and the side face of the case, are formed by insert-molding. Matching capacitors C1, C2, and C3 are connected between the ports P1, P2, and P3 and the ground electrodes provided in the resin case 7. A terminating resistor R is connected between an electrode connected to the port P3 and the ground electrode. A lower yoke 8 made of magnetic metal is combined with the upper yoke 2 to form a closed magnetic circuit, and thereby, a magnetic field generated by the permanent magnet 3 is applied to the ferrite 54 in the thickness direction thereof.

FIG. 2 is an equivalent circuit diagram of the isolator.

In FIG. 2, reference numerals L1, L2, and L3 designate equivalent inductors formed by the central conductors 51, 52, and 53 and the ferrite 54. The capacitances of the capacitors C1, C2, and C4 are matched with the inductances of the inductors L1, L2, and L3 so that a low insertion loss characteristic can be obtained over a predetermined bandwidth having the center at a predetermined frequency. A signal input via the input terminal 71 is output via an output terminal 72. A signal input via the output terminal 72 is terminated by the resistor R, substantially not output to the input 71 side.

As the properties of the permanent magnet 3 shown in FIG. 1, a magnet having a residual flux density of at least 0.420 [T], a coercive force in a forward direction (iHc) of at least 344 [kA/m], and a coercive force in a reverse direction (bHc) of at least 320 [kA/m] is used. For conventional permanent magnets, the magnetic flux density is about 0.38 [T]. Accordingly, in the case in which a magnetic field as high as that conventionally employed is applied to the magnetic assembly, the thickness of the magnet can be reduced by 10% or greater than that of the conventional magnet by use of a permanent magnet having the above-described residual flux density. Conventionally, the thickness of permanent magnets most used in smallest isolators is 1 mm. Thus, the thickness can be reduced to be sufficiently less than 0.9 mm.

The experimental results of the characteristics of nonreciprocal circuit devices and the sizes thereof, obtained when the residual flux density, the coercive force, ad the size of the magnets are varied, are shown below.

TABLE 1

| | | | | | thick- | |
|---|---|---|---|---|---|---|
| | magnetic | | | in- | ness | |
| | flux | coercive | coercive | sertion | of | height |
| | density | force | force | loss | magnet | of |
| | Br [T] | iHc [kA/m] | bHc [kA/m] | [dB] | [mm] | product |
| (1) | 0.38 | 290 | 270 | 0.33 | 0.90 | 1.90 |
| (2) | 0.40 | 310 | 290 | 0.33 | 0.85 | 1.86 |
| (3) | 0.42 | 344 | 320 | 0.32 | 0.80 | 1.81 |
| (4) | 0.46 | 365 | 340 | 0.32 | 0.75 | 1.77 |

In the rows (3) and (4) of Table 1, the results of the embodiment of the present invention are shown. In the rows (1) and (2), the results obtained when the residual flux density and the coercive force of the permanent magnet depart from the scope of this invention are shown as an example. The lengths and the widths of the magnets are constant, and only the thicknesses thereof are different.

As seen in the above description, a low insertion loss characteristic can be obtained by use of a permanent magnet which has a residual flux density of at least 0.420 [T], a forward coercive force (iHc) of at least 344 [kA/m], and a backward coercive force (bHc) of at least 320 [kA/m], even though the thickness of the permanent magnet is reduced. Thereby the overall thickness of the device can be reduced.

If the thickness of the magnetic circuit part excluding the permanent magnet, especially, the thickness of the ferrite is reduced, this is effective in reducing the whole height of the circuit device, but the magnetic loss in the ferrite portion is increased with the thickness of the ferrite being reduced, which causes the electric characteristic thereof as a nonreciprocal circuit device to be deteriorated. According to the present invention, the height of the device can be reduced to the order of several tenth millimeters (0.x millimeters) without reducing the thickness of the ferrite. Thus, this is very effective in reducing the overall size of the nonreciprocal circuit device.

However, when the thickness of the permanent magnet is reduced, the diamagnetic field is increased, and the withstanding property for changes in external temperature is deteriorated. That is, phenomena such as thermal demagnetization or the like are ready to be caused. To the contrary, when the coercive force of the permanent magnet is within the above-described range, the withstanding property for temperature comparable to that of the conventional permanent magnet can be obtained.

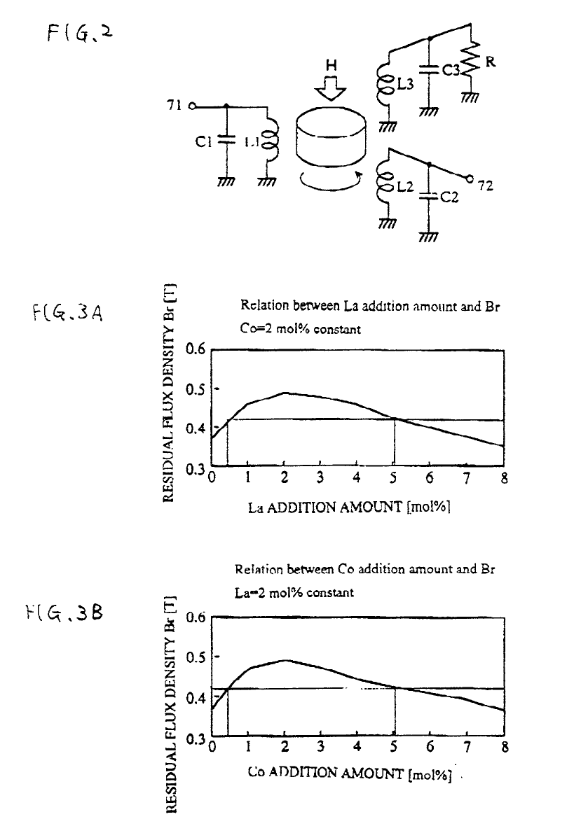

Referring to the permanent magnet having the above magnetic properties, specifically, a ferrite magnet is used, and lanthanum and cobalt are added therein. By addition of lanthanum and cobalt to the ferrite magnet, the physical properties, that is, the residual flux density and the coercive force are improved. FIGS. 3A and 3B show changes in the residual flux density characteristic, based on the addition amounts of lanthanum and cobalt, as an example. FIG. 3A shows one of the examples, obtained when the addition amount of Co (cobalt) is constant, that is, 2 mol %, and the addition amount of La (lanthanum) is varied in the range of 0 to 8 mol %. FIG. 3B shows the other example, obtained when the addition amount of La (lanthanum) is constant, that is, 2 mol %, and the addition amount of Co (cobalt) is varied in the range of 0 to 8 mol %.

As seen in FIG. 3A, when the addition amount of cobalt is 2 mol %, the residual flux density Br exhibits at least 0.42 [T] by setting the addition amount of lanthanum to be in the range of from 0.5 mol % to 5 mol %. Moreover, as seen in FIG. 3B, when the addition amount of lanthanum is 2 mol %, the residual flux density Br exhibits at least 0.42 [T] by setting the addition amount of cobalt to be in the range of from 0.5 mol % to 5 mol %.

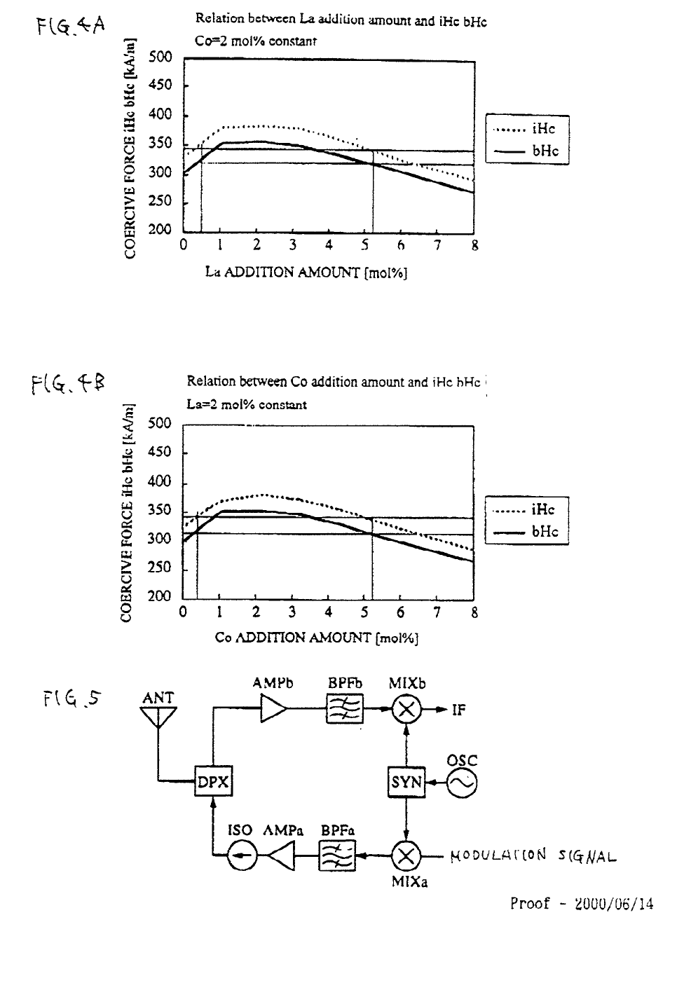

FIG. 4 shows changes in the coercive forces, based on the addition amounts of lanthanum and cobalt. FIG. 4A shows changes in the coercive forces iHc and bHc, obtained when the addition amount of cobalt is constant, that is, 2 mol %, and that of lanthanum is varied from 0 to 8 mol %. FIG. 4B shows changes in the coercive forces iHc and bHc, obtained when the addition amount of lanthanum is constant, that is, 2 mol %, and that of cobalt is varied from 0 to 8 mol %.

As seen in FIG. 4A, when the addition amount of cobalt is 2 mol %, the coercive force iHc exhibits at least 344 [kA/m], and the coercive force bHc exhibits at least 320 [kA/m] by setting the addition amount of lanthanum to be in the range of from 0.5 mol % to 5 mol %. Moreover, as seen in FIG. 4B, when the addition amount of lanthanum is 2 mol %, and that of cobalt is in the range of from 0.5 mol % to 5 mol %, the coercive force iHc becomes at least 344 [kA/m], and the coercive force bHc becomes at least 320 [kA/m] by setting the addition amount of cobalt to be in the range of from 0.5 mol % to 5 mol %.

As described above, the changes in the residual flux density and the coercive forces, caused by the changes in the addition amounts of lanthanum and cobalt have a convex form in the curves of FIGS. 3A and 3B and FIGS. 4A and 4B, respectively. Probably, the reason lies in that when the lanthanum and the cobalt, when the addition amounts are too small, have less effects on the improvement of the residual flux density and the coercive forces, and when the addition amounts are excessively large, the sintering densities are decreased, resulting in no effects on improvement of the residual flux density and the coercive forces.

As seen in the above results, by setting the addition amount of lanthanum at a predetermined amount in the range of from 0.5 mol % to 5 mol %, and moreover, setting that of cobalt at a predetermined amount in the range of from 0.5 mol % to 5 mol %, the properties of a residual flux density of at least 0.42 [T], a coercive force iHc of at least 344 [kA/m], and a coercive force bHc of at lest 320 [kA/m] can be realized.

A ferrite having a temperature coefficient of the saturation magnetization substantially equal to that of the permanent magnet is selected as the ferrite 54 for use in the magnetic assembly 5 shown in FIG. 1. This can suppress changes in characteristic of the isolator (shift of the center frequency in the frequency band where the low insertion loss characteristic can be obtained), caused by changes in temperature, to the greatest possible degree. This is because the saturation magnetization of the ferrite and the magnetic force applied to the ferrite are changed at the same ratio in the same direction, caused by changes in temperature, and therefore, the operating point of the ferrite is constant, irrespective of the changes in temperature.

Generally, the temperature coefficient of the saturation magnetization of ferrite is in the range of from −0.12%/°C. to −0.35%/°C. A ferrite exhibiting a predetermined temperature coefficient of saturation magnetization in this range can be selected. Accordingly, the temperature coefficient of the residual flux density Br of the permanent magnet is determined so as to be in the range of from −0.12%/°C. to −0.35%/°C. in which the temperature coefficient of the residual flux density Br is substantially equal to that of the saturation magnetization of the ferrite.

Hereinafter, an example of a communication device using the above-described isolator will be described with reference to FIG. 5. In FIG. 5, a transmission-reception antenna ANT, a diplexer DPX, band-pass filters BPFa and BPFb, amplifier circuits AMPa and AMPb, mixers MIXa and MIXb, an oscillator OSC, and a frequency synthesizer SYN are shown. The MIXa modulates a frequency signal output from the SYN with a modulation signal. The BPFa causes the signal in the transmission-reception frequency band only to pass. The AMPa power-amplifies the signal, and transmits it from the ANT via an isolator ISO and the DPX, The AMPb amplifies a signal output form the DPX. The BPFb causes the signal amplified in the AMPb and ranging only in the reception frequency band to pass. The MIXb mixes a frequency signal output from the SYN and the reception signal, and outputs the intermediate frequency signal IF. In the communication device having this configuration, as the isolator ISO, the element having the configuration and the characteristics illustrated in FIGS. 1 to 4 is used.

Since the coercive force of the permanent magnet used in the isolator ISO is high, occurring of thermal demagnetization is suppressed. Thus, even though the ambient temperature is largely changed, deterioration of the characteristics of the isolator can be prevented. Accordingly, the performance of the communication device suffers no damages. In addition, since the isolator is reduced in size, height and weight, the design flexibility of the communication device is enhanced. A communication device having high performances and a small-size can be provided without deterioration in the characteristics. Moreover, temperature stresses, caused by changes in ambience temperature or self-heating, are applied to the isolator in the state that the isolator is mounted on the communication device. In spite of these temperature stresses, satisfactory communication performances can be achieved, attributed to the high temperature characteristics of the isolator. Thus, the temperature range in which the communication device is used can be increased.

According to the present invention, the height of the nonreciprocal circuit device can be reduced to the order of 0.5 to 0.5 mm without the electrical characteristics of the element being deteriorated. This contributes to reduction in thickness of the communication device having the nonreciprocal circuit device mounted thereon.

Moreover, since the coercive force of the permanent magnet is large, the thermal demagnetization is suppressed. Even if the ambience temperature is considerably changed, deterioration of the characteristic of the nonreciprocal circuit device can be prevented. Accordingly, the communication performance of the communication device having the nonreciprocal circuit device mounted thereon suffers no damages.

Furthermore, the residual flux density and the coercive forces can be enhanced by use of the ferrite magnet having predetermined amounts of lanthanum and cobalt added thereto. Thus, without the characteristic being deteriorated, the design flexibility of the nonreciprocal circuit device for reduction in size, height, and weight is increased.

Changes in characteristic of the isolator, based on changes in temperature can be reduced to the highest possible degree by selecting the ferrite of which the temperature coefficient of the saturation magnetization is equal to that of the residual flux density of the permanent magnet, and determining the temperature coefficients in the range of from −0.12 to −0.35%/°C., respectively. Thus. the communication performance stable in a wide range can be attained.

What is claimed is:

1. A nonreciprocal circuit device comprising:
a plurality of central conductors arranged so as to intersect each other in the electric insulation state;
a ferrite disposed in contact with the intersection portion of the plurality of central conductors; and
a permanent magnet for applying a direct-current magnetic field to the ferrite, said permanent magnet having a residual flux density of at least 0.420 [T], a coercive force iHc of at least 344 [kA/m], and a coercive force bHc of at least 320 [kA/m].

2. A nonreciprocal circuit device according to claim 1, wherein the permanent magnet is a ferrite magnet having lanthanum and cobalt added thereto.

3. A nonreciprocal circuit device according to claim 2, wherein the addition amount of lanthanum contained in the ferrite magnet is in the range of from 0.5 mol % to 5 mol %, and the addition amount of cobalt is in the range of from 0.5 mol % to 5 mol %.

4. A nonreciprocal circuit device according to any one of claims 1 to 3, wherein the permanent magnet has a thickness of 1 mm or less.

5. A nonreciprocal circuit device according to any one of claims 1 to 3, wherein the temperature coefficient of the residual flux density of the permanent magnet is substantially equal to the temperature coefficient of the saturation magnetization of the ferrite.

6. A nonreciprocal circuit device according to claim 5, wherein the temperature coefficient of the residual flux density of the permanent magnet and the temperature coefficient of the saturation magnetization of the ferrite are determined so as to be in the range of from −0.12%/°C. to −0.35%/°C.

7. A communication device including the nonreciprocal circuit device as set forth in claim 1.
